(19) United States
(12) Patent Application Publication
(10) Pub. No.: US 2014/0111851 A1
(43) Pub. Date: Apr. 24, 2014

(54) APPARATUS MOUNTED WITH HEAT-INSULATION LIGHT-GUIDE FILM

(71) Applicant: EXTEND OPTRONICS CORP., Taoyuan County (TW)

(72) Inventors: CHAO-YING LIN, NEW TAIPEI CITY (TW); JEN-HUAI CHANG, TAOYUAN COUNTY (TW)

(73) Assignee: EXTEND OPTRONICS CORP., TAOYUAN COUNTY (TW)

(21) Appl. No.: 13/655,643

(22) Filed: Oct. 19, 2012

(51) Int. Cl. G02B 5/28; G02B 27/28; F21V 9/04

(52) U.S. Cl. 359/359; 359/584; 359/485.01

(57) ABSTRACT

The disclosure is related to an apparatus mounted with a heat-insulation light-guide film. The apparatus is a support with carriers capable of adjusting the received light quantity. The carrier is such as the slat of a shutter device and whose angle is adjustable. The heat-insulation light-guide film is exemplarily mounted on the slat, and which is made of a multilayer membrane and a surface textural layer in combination. The multilayer membrane includes multiple films and the adjacent layers are with different indexes of refraction. The materials and thicknesses of the membrane are configured to specify an optical band of light to be reflected. The surface textural layer is for guiding an incident light directed to the structure. The apparatus is as required to adjust the angle of the light hitting the film, and is applicable to a window for uses of heat-insulation, anti-glare, and illumination.

### BACKGROUND OF THE INVENTION

1. Field of the Invention

The present invention is related to an apparatus disposed with a heat insulation light-guide film; in particular, to a window device adhered to the heat insulation light-guide film for adjusting light quantity entering indoor from a light source.

2. Description of Related Art

A general multilayer film is composed of a plurality of stacked films that have variant indexes of refraction. The structure having the plurality of films is able to provide various functionalities. For example, the multiple layers of films form the device with heat insulation, light filtering, light polarization, or anti-glare. The main ingredient of the materials forming the multilayer structure is polymer.

For the case using the heat insulation film, the heat insulation film is mostly provided for reflecting or absorbing the solar energy. In particular, the multiple thin films forming the heat-insulation device include the special materials having substances capable of reflecting or absorbing the infrared. For example, a metal reflective layer may be coated upon the surface of the multilayer film. The metal is such as silver, titanium, iron, or aluminum being capable reflecting the incident energy to outdoor. This kind of the conventional art with reflective heat-insulation may block the solar heat, but cause the indoor reflection at the same time. Thus the conventional scheme of reflective heat insulation may be ineffective since it piles up the heat in the heat-insulation film and leads to secondary exothermic reaction.

The relevant prior art to the heat-insulation film may refer to a heat-insulation film with nano structure disclosed in Taiwan, R.O.C Patent No. I346215, published on Aug. 1, 2011. The provided heat-insulation film includes a nano-structure layer and a metal layer formed upon a prepared substrate. The metal layer is provided for implementing the effect of heat insulation by blocking the infrared as receiving incident light. The metal layer has a major substance made of the material selected from gold, silver, aluminum, nickel, copper, chromium oxide, and tin oxide, and/or indium tin oxide (ITO). This metal layer may effectively block the infrared for heat insulation, but it still meets the problem of piling up the heat.

To the function of light guide, the multiple layers of the conventional multilayer structure may be able to change the light path via their various indexes of refraction. However, the conventional multilayer structure still lacks of solution to effectively guide the outdoor light to illuminate the indoor room.

### SUMMARY OF THE INVENTION

Disclosure is an invention related to multilayer structure having functions of heat insulation and light guide. This multilayer structure may be integrated to a window device which is able to adjust the amount of incident light from a light source. The window device is such as a shutter. In one of the embodiments, the slats of the shutter are adhered with one or more heat insulation light-guide film. Any optical feature made by design of the multilayer structure is relying on surface structure. Thus the claimed multilayer structure is simultaneously to render heat insulation and light guide. Furthermore, the multilayer structure may be applied to another device which allows adjusting the angle of incident light to the heat-insulation light-guide device.

The multilayer structure in accordance with the present invention is capable of effectively reflecting the optical band of infrared. In particular, the infrared being reflected is also based on an optical interference principle, and allowed to provide effect of heat insulation. However, the heat insulation based on the interference principle is different from the widespread device added with metal oxides for absorbing the infrared. It is noted that the conventional way to absorb the infrared may not completely release heat and easily pile up the heat in the structure.

According to one embodiment, the main structure of the heat-insulation light-guide film includes a multilayer membrane composed of a plurality of layers of polymers made of polymeric materials. The adjacent thin films are provided with different indexes of refraction. The optical band to be reflected is manufactured by controlling multilayer membrane's compositions and each layer's thickness. The heat-insulation light-guide film may also include a surface textural layer adhered to the multilayer membrane. The surface textural layer is configured to guide the path of incident light entering the heat-insulation light-guide film. An adhesive is provided to combine the multilayer membrane and the surface textural layer. The claimed heat insulation light-guide film provides a substrate between the mentioned membrane and the surface textural layer.

The heat-insulation light-guide film may also be disposed onto a carrier. This carrier is composed of one or more carrying members, and the each carrying member is capable of adjusting the amount of incident light. The carrier is exemplarily to be a shutter, and the carrying member is such as the slats disposed on the shutter. The combination of heat insulation light-guide film and the carrier may be made by the side of the surface textural layer. A low-refractivity glue may be used to fill in the space between the carrier and the surface textural layer. Alternatively, a gas may be filled in the space. The gas makes impression on insulating heat or blocking light with a specific optical band.

In an exemplary example, the heat-insulation light-guide film is configured to block an infrared light through adjustment of the composition of multilayer membrane and its thickness. The multilayer membrane renders a polarization appearing refractivity difference along different directions through a stretching process. The cross-section of the surface textural layer is preferred to appear to a geometric shape extended over a whole substrate surface. The extended structure is such as columnar structure. The columnar structure may be a singular type or mixing types of the columnar structure.

In one further embodiment, the multilayer membrane may be composed of a plurality of multilayer film module. The each multilayer film module has its own individual function, and is composed of a plurality of thin films. It is noted that the adjacent thin films have different indexes of refraction.

### BRIEF DESCRIPTION OF THE DRAWINGS

The accompanying drawings which are incorporated in and which constitute a part of this specification illustrate several exemplary constructions and procedures in accordance with the present invention and, together with the general description of the invention given above and the detailed description set forth below, serve to explain the principles of the invention wherein:

FIG. 1 shows a schematic diagram of a heat insulation light-guide film in first embodiment of the present invention;

FIG. 2 shows a schematic diagram of a heat insulation light-guide film in second embodiment of the present invention;

FIG. 3 shows a schematic diagram of a heat insulation light-guide film in third embodiment of the present invention;

FIGS. 4A through 4E schematically show the design of the heat insulation light-guide film in an embodiment of the present invention;

FIG. 5 is a schematic diagram showing surface structure of the heat insulation light-guide film in first embodiment of the present invention;

FIG. 6 is a schematic diagram showing surface structure of the heat insulation light-guide film in second embodiment of the present invention;

FIGS. 7A and 7B show the heat insulation light-guide film applied to a window in one embodiment of the present invention;

FIG. 8 shows a schematic diagram of a device having the heat insulation light-guide film in one embodiment of the present invention;

FIGS. 9A and 9B schematically show the heat insulation light-guide film disposed on a carrying member in accordance with the present invention;

FIGS. 10A and 10B schematically show the device having the heat insulation light-guide film in accordance with the present invention.

### DETAILED DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Disclosure is related to a heat insulation light-guide film, and an apparatus adopting the same. The main body of the heat insulation light-guide film is multilayer structure. The structure is preferably made of a plurality of stacked polymeric materials, and the adjacent layers have different indexes of refraction. Thus the multilayer structure embodies the film to provide various functionalities. In particular, the heat insulation light-guide film therefore carries out heat insulation as effectively reflecting the infrared. The heat-insulation light-guide film may be combined with a carrier which is the fabrication of one or more angle-adjustable carrying members. For an exemplary example, the heat-insulation light-guide film is disposed on a window frame, especially onto the many angle-adjustable carrying members in the frame. Therefore, the many angle-adjustable carrying members may drive the angle of incident light entering the heat-insulation light-guide film.

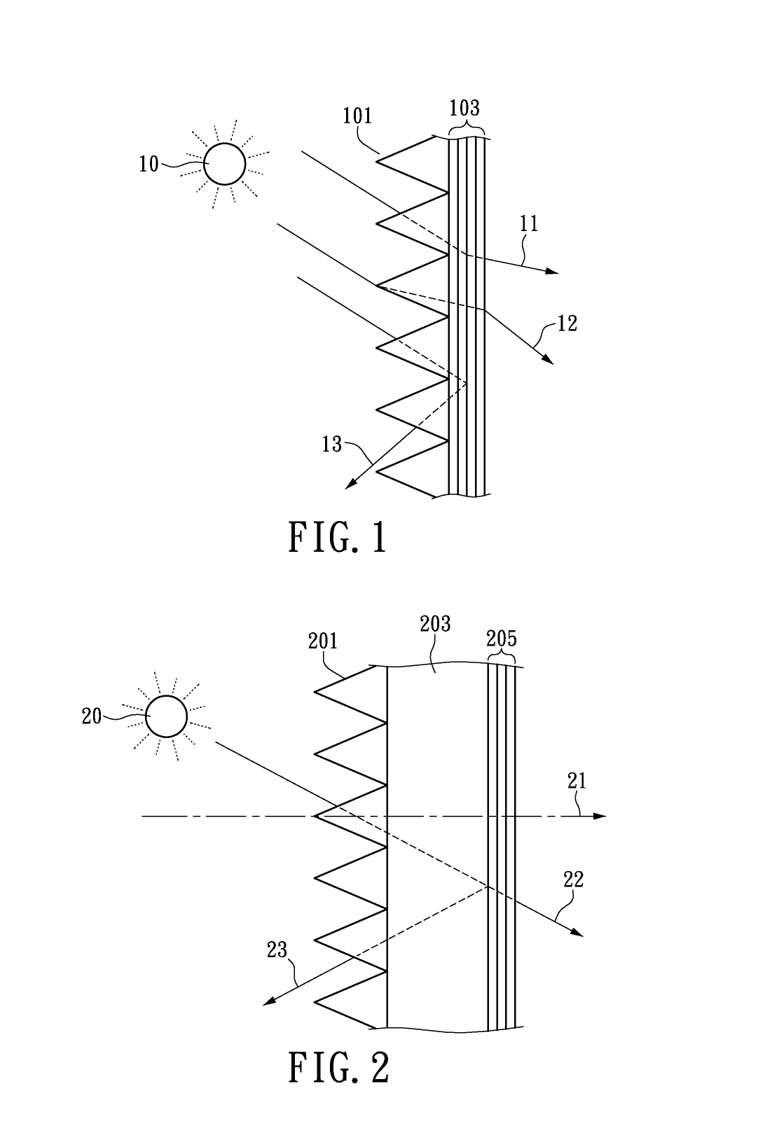

One main embodiment of the heat-insulation light-guide film in accordance with the present invention is schematically referred to FIG. 1.

In the diagram, one multilayer structure is formed by integrating a plurality of multiple layers of thin films. The multilayer structure may be fabricated of 20 through 200 inter-stacked layers of the thin films. The adjacent thin films have different indexes of refraction. The whole multilayer structure may have at least two indexes of refraction, namely at least two materials thereof. The designed thickness of the structure may fall within a specific range of optical wavelength. The multilayer structure exemplarily integrates a surface textural layer 101 and a multilayer membrane 103. This membrane 103 may therefore have a certain structural rigidity since it is composed of a plurality of layers of polymeric materials. One side of the multilayer membrane 103 is formed with a surface textural layer 101 which has a surface microstructure pattern.

The multilayer membrane 103 is composed of a plurality of stacked materials having different indexes of refraction between the adjacent layers. The design of multiple layers of thin films renders the functionalities of heat insulation, variant colors by controlling transmittal or reflective colored light, optical polarization, anti-glare, or guiding the incident light to function indoor illumination.

The effect of heat insulation is because of disposing the claimed heat-insulation light-guide film rather than the conventional technology using additive with the compositions capable of absorbing light with specific optical band. The heat-insulation light-guide film is able to block the infrared or ultraviolet by functioning reflection and interference rendered by the multilayer structure. However the heat-insulation light-guide film preferably allows the visible light to pass.

In one further embodiment, the multilayer structure itself or using dyes may form the colored multilayer membrane 103. It is because of the material compositions and the thickness of the multilayer membrane 103 dominates the effect of optical reflection or/and interference. Relevant experiment shows that a specific optical band of the light is reflected by configuring the thickness of the multilayer membrane 103. The material compositions of multilayer membrane 103 may be a factor in tuning the effect of reflection to the light with a specific wavelength. It is emphasized that the claimed heat-insulation light-guide film is not an absorptive design for the light, and therefore the heat will not be piled in the structure. Noted that, the claimed film has no any additive of absorptive particles, and have high efficiency of polarization and anti-glare.

The multilayer membrane 103 is formed by performing a co-extrusion procedure to a plurality of layers of materials. Alternatively, laminating the plurality of layers of thin films is also one solution to fabricate the multilayer membrane 103. Further, a microstructure with a pattern is formed on surface of the surface textural layer 101. The manufacturing procedure of rolling or imprinting may be adopted to form the pattern onto the surface of the multilayer membrane 103. The mentioned co-extrusion process is also provided to form the multilayer membrane 103 and the surface structure in one process. It is noted that the surface structure is formed by an imprinting method in the later half process. However, in one further embodiment, a film with the surface structure may be formed in advance, and then it is combined with the multilayer membrane 103.

The surface textural layer 101 is to direct the path of incident light entering the heat insulation light-guide film. That is, the light entering the heat-insulation light-guide film is guided to another direction. For example, a light source (10) is introduced to generating light entering the heat-insulation light-guide film. While the light passes through the surface textural layer 101 and the multilayer membrane 103, the refractive lights (11, 12) or reflective lights (13) can be formed. It is noted that the heat-insulation light-guide film is designed based on the demand of refraction or reflection rendered by its structure.

In one constructive embodiment in accordance with the present invention, the outdoor light, such as sunshine, is guided to indoor, even though guided to above of indoor to be the indoor illumination. The heat-insulation light-guide film in some other embodiments provides to be cooperated with an indoor light guide. The light guide allows the incident light to be effectively guided to the space as required. For example, the light may be guided to an indoor ceiling and averagely distributed over the ceiling for providing good illumination.

A plurality of inter-stacked films are combined to form the multilayer membrane 103 in the heat-insulation light-guide film. A stretching process may be then applied to the formed multilayer membrane 103. Such as a uniaxial stretching or a biaxial stretching process, the stretching process is applicable to manufacture the multilayer structure to have feature of polarization. The multilayer structure may be with variant indexes of refraction along different directions by performing the uniaxial stretching process or the asymmetric biaxial stretching process. The variant indexes of refraction over the directions form the polarization of the multilayer structure. It is noted that the biaxial stretching process may be performed by a sequential biaxial process or a simultaneous biaxial process. However, the multilayer structure may not have feature of polarization if it is applied with the symmetric biaxial stretching process. On the contrary, the structure will be with polarization if the asymmetric axial stretching process is performed.

One further embodiment of the claimed heat-insulation light-guide film is schematically shown in FIG. 2.

To form the heat-insulation light-guide film, a substrate 203 is firstly prepared. The substrate 203 may be made of glasses or polymeric materials. One side of the substrate 203, that is the side toward a light source 20, is formed with a surface textural layer 201. In an embodiment, the surface textural layer 201 may be formed by performing a rolling or imprinting procedure onto the surface of substrate 203. One of the objectives of the surface textural layer 201 is to guide the incident light into the structure by means of a principle of optical reflection. Glue is adopted to combine the surface textural layer 201 with the substrate 203. The glue in one preferred embodiment can be transparent glue such as pressure-sensitive glue, which provides stickiness as under a pressure.

A multilayer membrane 205 is formed on the side of the substrate 203 of the heat-insulation light-guide film. The multilayer membrane 205 is composed of inter-stacked films with various indexes of refraction. The design of multiple layers is configured to block the light with a specific optical band, especially to implement heat insulation. The multilayer structure also configures the variant colors, namely allows the colored light to be transmitted or reflected. Furthermore, the multilayer structure may achieve polarization, anti-glare, or guiding the incident light to provide indoor illumination.

The described multilayer membrane 205 may be formed by a co-extrusion process in one step. The layers of the membrane 205 may layer-by-layer be extruded. After that, the multilayer membrane 205 is adhered to the substrate 203 with application of pressure-sensitive glue (PSA), optical glue, or by optical curing.

The shown light source 20 is such as sunshine that radiates the heat-insulation light-guide film through the side of the surface textural layer 201. As shown in the diagram, the incident light is such as the light (21) passing through the multilayer structure, the reflective light (23), or/and the refractive light (22).

In the embodiment, the surface textural layer 201 effectively guides the light, in particular to guide the outdoor sunshine toward the indoor. The light guided to the above of the space may successfully implement the indoor illumination. A light guide may also be applied to the formed indoor illumination so as to provide uniform illumination. By adjusting the material compositions and thickness of the multilayer membrane 205, it is configured to insulate heat by controlling the optical band to be reflected. The mentioned optical band is for example within infrared or ultraviolet band.

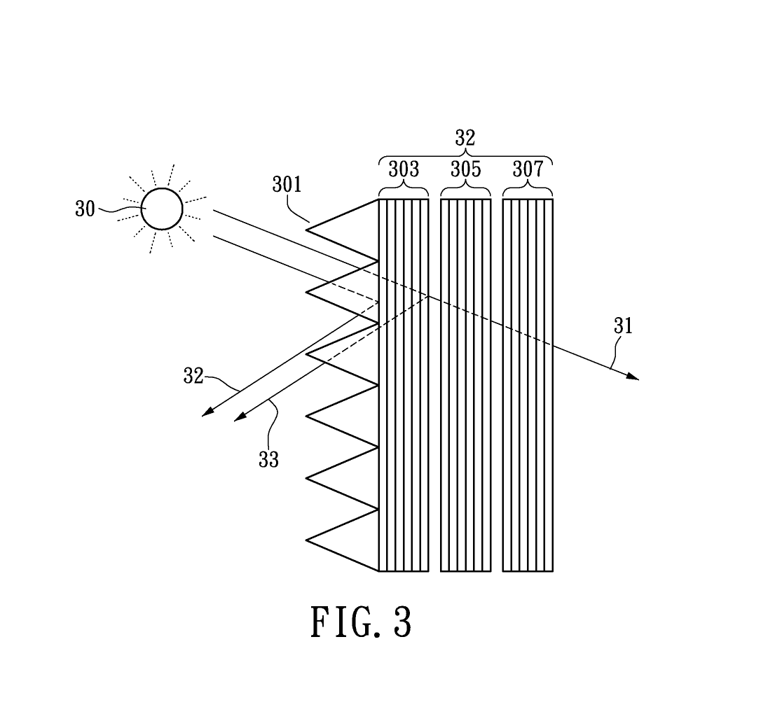

Reference is made to FIG. 3. A shown heat-insulation light-guide film has a surface textural layer 301 formed on its surface. Main purpose of the heat-insulation light-guide film is to guide the incident light toward a specified direction. A multilayer membrane 32 is a modular element of the film. That means the multilayer membrane 32 may be fabricated of one or more multilayer film modules (303, 305, 307) having various functionalities as required.

The multilayer membrane 32, in the current example, includes a first multilayer film module 303, a second multilayer film module 305, and a third multilayer film module 307. The every multilayer film module is made of inter-stacking a plurality of thin films which have different indexes of refraction between adjacent films. The thickness and each layer's material of the membrane 32 are configured to specify the functionality of blocking or allowing passing the light with a specific band. Therefore, the multilayer membrane 32 generates the effects including heat insulation, altering colors, polarization, anti-glare, and light guide. As required, the membrane 32 is selectively fabricated of one or more multilayer film modules, in which the every module has its individual functionality. All the mentioned functionalities may be included in one membrane 32.

Further, the multilayer film module may be manufactured by performing a co-extrusion process, or laminating the thin films which are separately made. Through the design of the multilayer film module configured to provide various functionalities, the claimed structure is provided to filter a specific optical band of light, conduct polarization, or/and insulating heat by blocking the infrared or ultraviolet.

A surface textural layer 301 is disposed onto surface of the multilayer membrane 32. The surface textural layer 301 is made by one of the following methods, and the methods are especially applicable to the claimed structure.

In one exemplary embodiment, a coating process is adopted to coat a polymeric material onto the multilayer structure. Next, an imprinting method is applied onto the surface to form the surface structure. For example, a mold or roll having a surface pattern may be adopted to perform the imprinting method. Alternatively, in one further embodiment, a membrane with surface structure may be firstly prepared. Then a transparent glue is applied to stick the membrane to the multilayer structure. The glue may be a kind of optical glue such as UV glue; therefore a UV curing method may be applied. Pressure-sensitive glue may be one solution thereof. Furthermore, a thermal curing method is also applied to shape the whole structure.

Refer to FIG. 3; a substrate (not shown) is disposed in the midst of the surface textural layer 301 and the multilayer membrane 32. The substrate and the every film are mostly the thermoplastic polymeric materials. The polymer is such as Poly(Methyl methacrylate) (PMMA), Polycarbonate (PC), (Methyl methacrylate)Styrene (MS), PolyStyrene (PS), a copolymer or one material selected from the group including Poly(Ethylene Terephthalate) (PET), Poly(Ethylene Naphthalate) (PEN), and Polypropylene (PP). However, the material of the substrate or the membrane 32 is not limited to the above-mentioned materials. The foregoing materials are also applicable to the layers in the heat insulation light-guide film.

The co-extrusion process is served to perform a uniaxial or biaxial stretching process on the plurality of layers of polymers so as to form the heat-insulation light-guide film. In which, the stretching process produces the difference of refractivity between the adjacent layers. Therefore, the heat-insulation light-guide film is bestowed with the property in which the variant index of refraction over the x direction and y direction. Or, it also renders the z-directional index of refraction to be different. If the structure is applied with a biaxial stretching process, a bi-refringent layer is formed. Moreover, the stretching process may be successively performed by a machine-directional (MD) biaxial stretching with several times and also by a transverse-directional (TD) biaxial stretching with times of stretch. Also, the process may be simultaneously performed by the machine-directional and transverse-directional biaxial stretching with times of stretch. After that, the variant index of refraction among the layers can be provided.

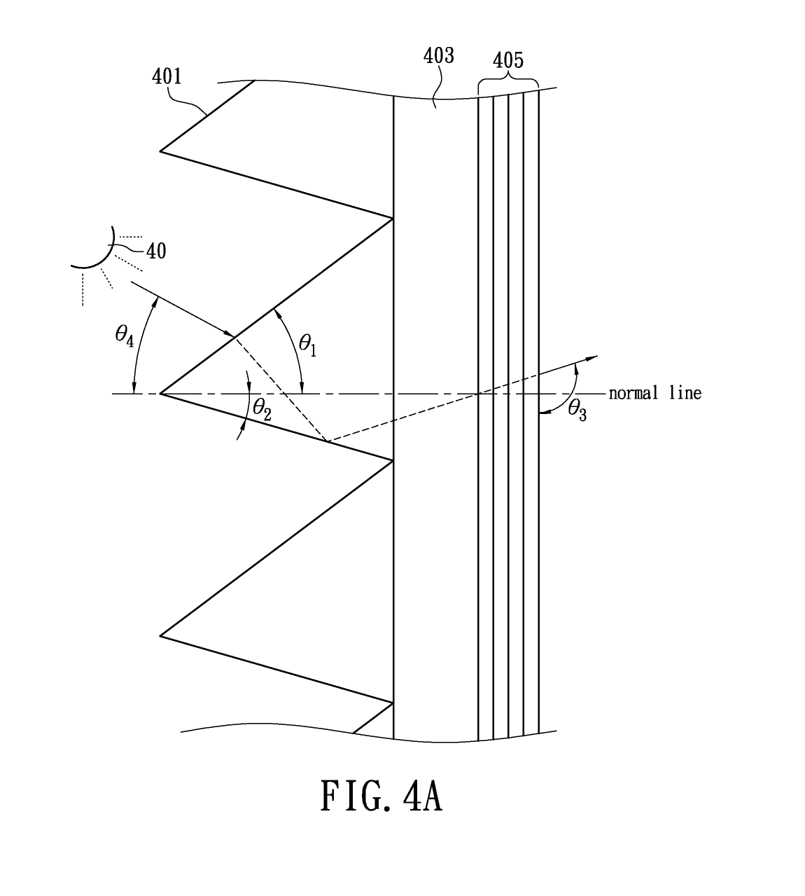

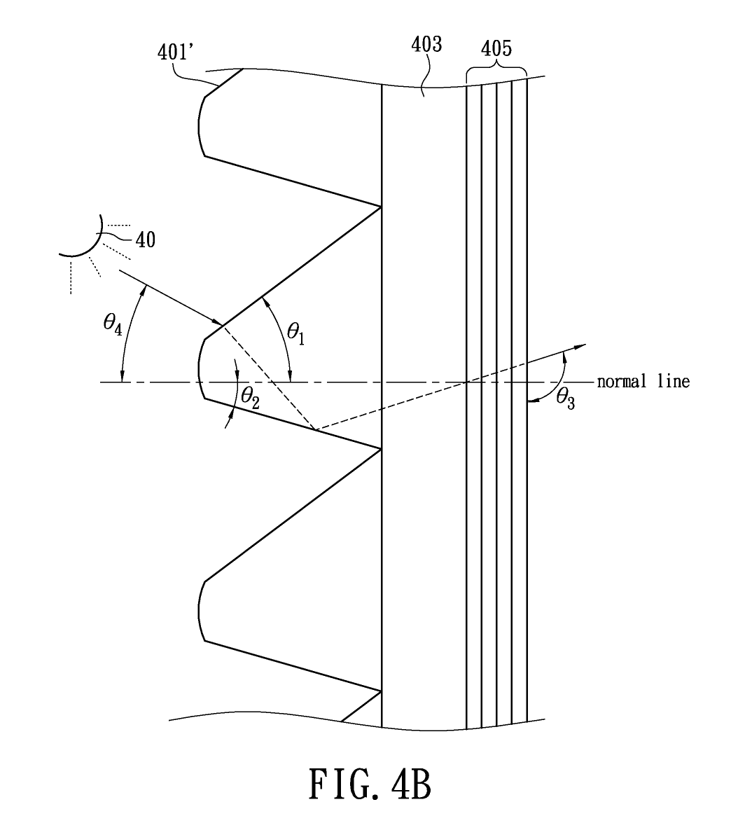

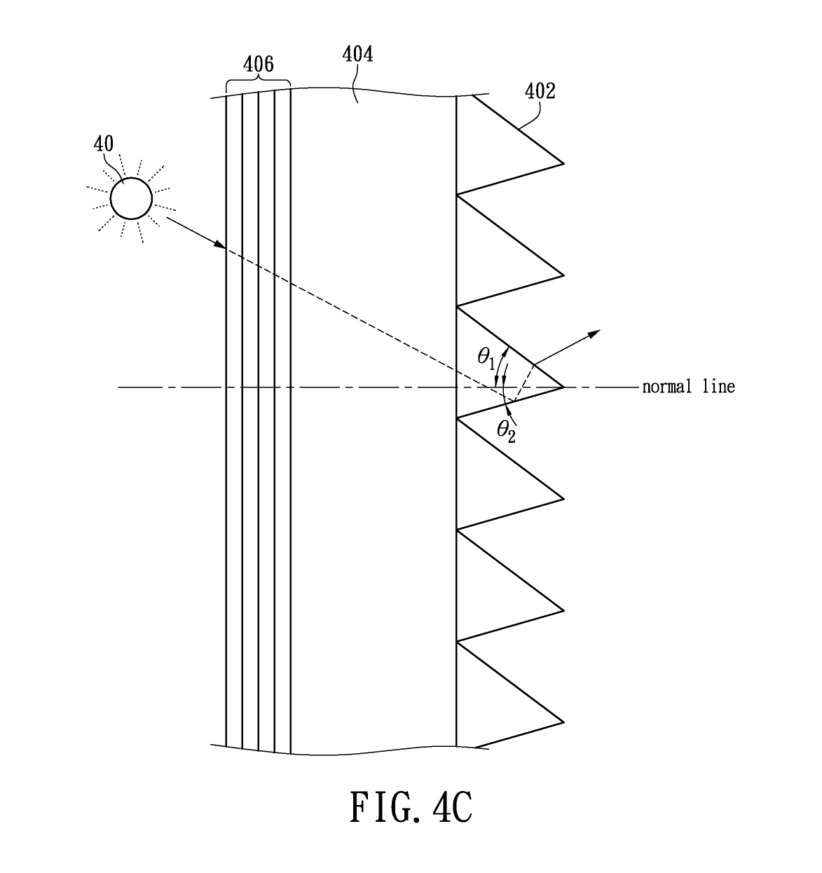

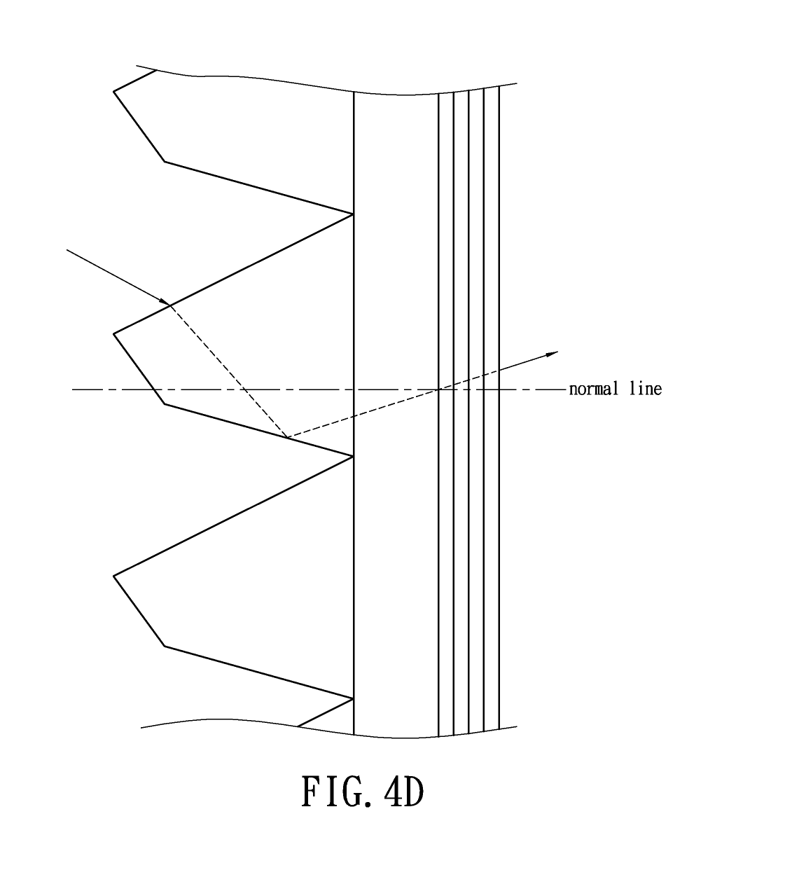

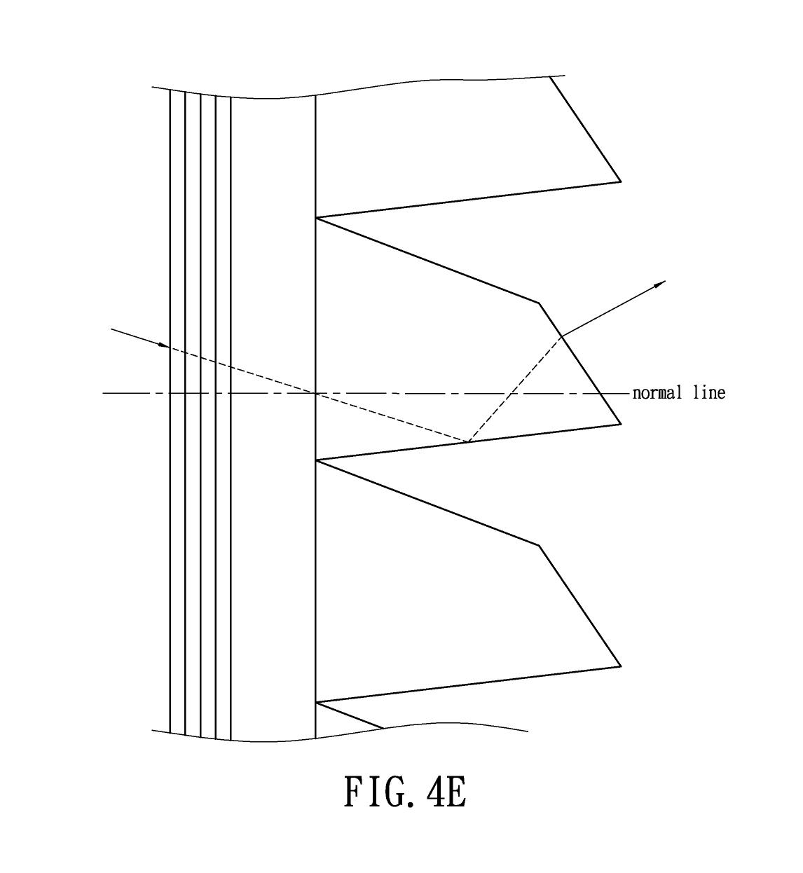

FIGS. 4A through 4E describe the design of the surface structure of the heat-insulation light-guide film in accordance with the various needs and applications.

The cross-sections described in the figures roughly show the similar geometric shapes of the surface structure. For example, the cross-section may be formed as a regular shape such as triangle or polygon, or irregular shape. The shape of cross-sectional matter may be extended over an entire column of the structure. That means the cross-section of the surface textural layer appears a geometric shape, and the structure with the geometric shape is such as columnar structure extended over the surface of substrate or membrane.

Reference is made to FIG. 4A. Relative to vertex of the triangular surface structure 401, two angles (θ₁ and θ₂) are formed opposite to a normal line perpendicular to the surface. A light source 40 enters the surface structure 401 on the side with the angle θ₁. The incident light forms an included angle θ₄ opposite to the normal line. For implementing guiding the incident light to pass through and to above of the space, the experiment appears the index of refraction of structure's material is around 1.5. If the angle θ₁ is set around 18 through 30 degrees, the angle θ₂ is preferred to 19 through 27 degrees. In the current example, the outdoor light is effectively guided to above of the indoor via the substrate 403 and the multilayer membrane 405. The thickness and the indexes of refraction of each layer and whole structure may dominate the result. The illumination is provided as an angle θ₃ is appeared between the transmittal light and the normal line.

One further embodiment shows various angles with respect to the claimed film formed by the incident light from the light source 40. Any modification related to the surface structure 401 is required. For example, the included angle θ₁ on the side with respect to a normal line is around 33 through 47 degrees, and θ₂ is preferably around 15 through 25 degrees.

According to the disclosure related to the present invention, the heat-insulation light-guide film may be installed at outdoor side. For example, the film may be mounted onto the surface of building window. However, the claimed structure may be blunted by years' erosion made by the environmental particles. Reference is made to FIG. 4B describing the surface structure 401′ of heat-insulation light-guide film is blunted. The blunt structure may result in altering the properties of surface structure. According to the result of experiment, any functional problem caused by the dirt-blunt structure can be avoided if the film is applied with a suitable cleaning means. Further, the functional problem can be avoided if the film may be applied with a self-clean substance or coated with a functional coating. The coating is such as Titanium dioxide of Titanium Oxide or any fine surface structure which is not easy stain dirt. However, those applications to the claimed film may not change the optical properties thereto. FIG. 4B gives proof of the optical properties of the surface structure 401′ may not too much affected by the surface treatment. The incident light may still be guided to indoor space when the described surface treatment is applied to the fabrication of substrate 403 and multilayer membrane 405.

FIG. 4C next shows an embodiment of the heat-insulation light-guide film. It is still noted that the surface structure 402 and multilayer membrane 406 is the main structure of the heat-insulation light-guide film. Both the structure 402 and membrane 406 may be mounted onto two sides of the substrate 404. The light from the light source 40, in accordance with the present embodiment, enters the film at the side of multilayer membrane 406.

The shown light radiates the heat insulation light-guide film from its light source 40 via the structure including the multilayer membrane 406 and substrate 404. The structure refracts the incident light, and the light enters the surface structure 402. A normal line perpendicular to the substrate 404 is illustrated. The cross section of the surface structure 402 is such as a geometric shape near a triangle. The normal line passes through a vertex of the triangle and forms two included angles which are represented by θ₁ and θ₂. When the light passes through the multilayer membrane 406 and substrate 404, the light is reflected by the side of the angle θ₁. The reflected light is again refracted by the side of the angle θ₂, and radiating to above.

Through the light tracks illustrated in accordance with the above described paths, it appears that the claimed heat-insulation light-guide film may effectively guide the incident light to above the other side for the purpose of illumination.

The related experiment appears that a preferred type of the surface structure of the heat-insulation light-guide film shown in FIG. 4C has the angle θ₁ with 25 through 35 degrees, and the angle θ₂ with 1 through 7 degrees.

It is noted that the mentioned angles may be configured based on the environment. If the light source is sun, an average position of the solar radiation may be referred to latitude of the present place. The radiation may be changed because of the optical properties of material of the surface structure. The index of refraction is one of the factors. The surface structure may be designed in consideration with the optical property of the multilayer structure associated with the surface structure.

Further, the cross section of the surface structure may be polygon. FIGS. 4D and 4E shows the surface structure is polygonal column.

Further, FIG. 4D schematically shows a heat-insulation light-guide film. The cross section of the surface structure is asymmetric polygon. The arrow denotes the light entering one side of the structure. The design of thickness and an overall index of refraction of the whole structure are configured to guide the incident light to the other side, or even form upward light.

Compared to the embodiment shown in FIG. 4D, FIG. 4E shows that the light enters the structure via the multilayer membrane firstly. And the light is guided to the other side and formed as an upward light by refraction via the surface structure.

In one embodiment of the surface textural layer upon the heat-insulation light-guide film, the surface textural layer is configurable in need of any requirement. The main function of the surface textural layer is to guide the incident light. In which the surface structure of the surface textural layer may be formed by performing an imprint process using template or rolling process. The surface structure is usually the structure having successive and regular variances for uniformly rendering refractive light.

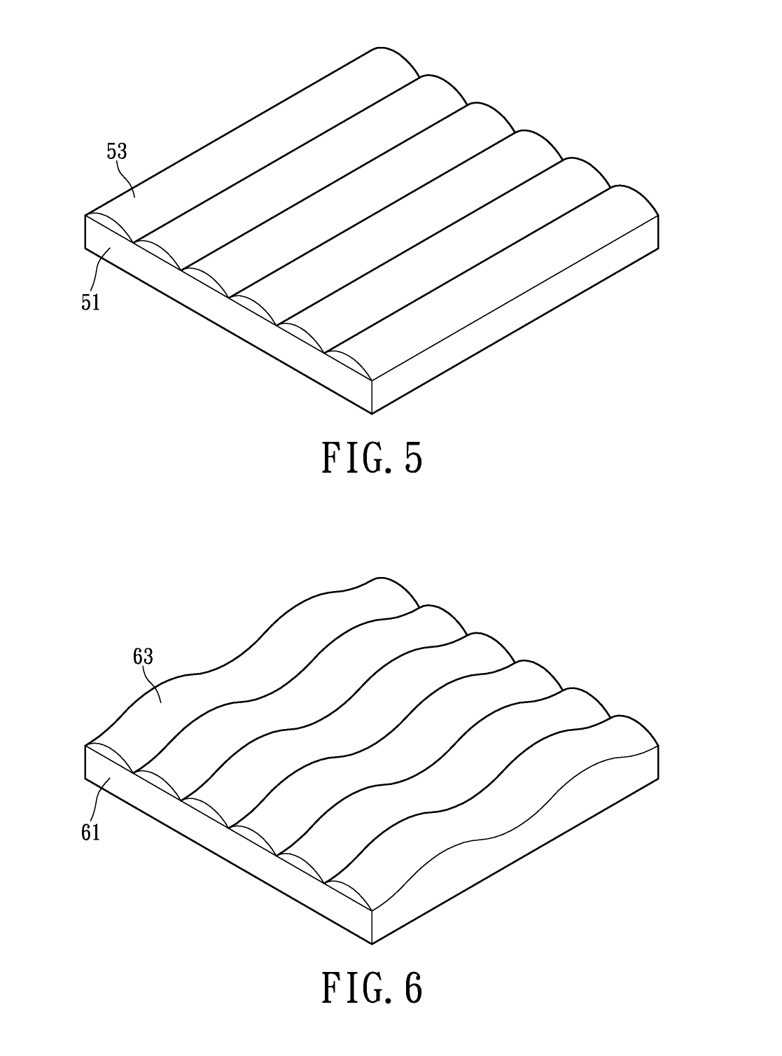

Reference is made to FIG. 5 showing one of the embodiments of the surface structure of the heat-insulation light-guide film. The surface structure 53 is formed as the structure with cross section having arc columnar feature on the substrate 51. The columnar structure extends over whole or part of the substrate 51. Ignoring the glass substrate, the substrate 51 may be the multilayer membrane in accordance with the present embodiment of the invention.

FIG. 6 shows a schematic diagram of the surface structure of the other embodiment of the present invention.

The present example appears that the cross section of the surface structure 63 of substrate 61 is arc-shaped. The arc-shaped surface structure 63 extends over whole or part of the substrate 63. The structure 63 is the undulate microstructure. In addition to the arc-shaped cross section, the columnar structure may have undulate microstructure. The structure 63 therefore is able to prevent the interference resulting in bright and dark bands.

The above-described shapes of cross section and extended columnar structure in the embodiments of the surface structure may not be used to limit the applicable types of the heat insulation light-guide film in accordance with the present invention.

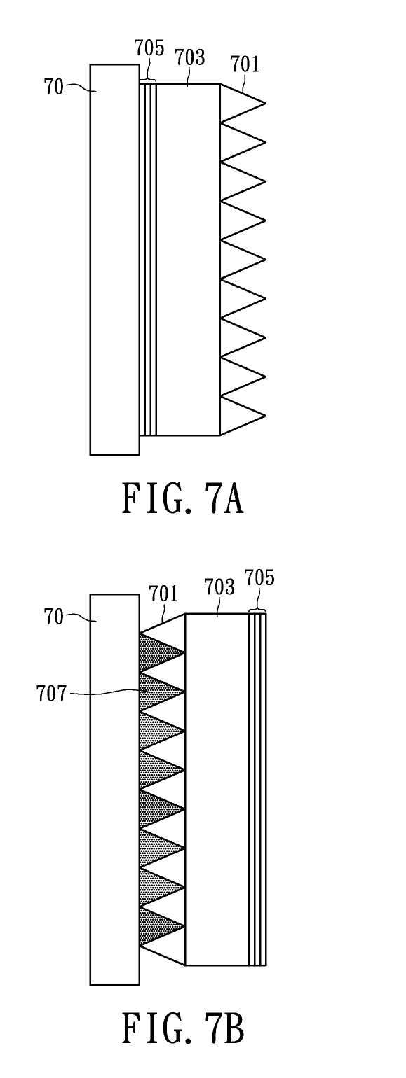

FIGS. 7A and 7B show the embodiments of the heat-insulation light-guide film applied to a window.

The heat-insulation light-guide film shown in FIG. 7A is exemplarily installed onto a transparent carrier 70. Pressure-sensitive glue which is adhesive under a pressure or optical glue may be adopted to adhere the heat-insulation light-guide film to an opening of the carrier 70. The carrier 70 is the transparent substrate such as glass or acrylic used in the window.

For example, the carrier 70 may be glass or acrylic used in the window as an opening of a building. The heat-insulation light-guide film is disposed onto one side of the carrier 70. The film may be the outdoor side or indoor side of the carrier 70. The film may be prevented from external contamination and damage if it is installed at the indoor side.

The heat-insulation light-guide film is essentially composed of a multilayer membrane 705 and a surface textural layer 701, or even having a substrate 703 to be a support of the multilayer membrane. The multilayer membrane 705 and the surface textural layer 701 are respectively mounted onto two sides of the substrate 703. According to the present example, the multilayer membrane 705 is combined with the carrier 70.

When the light radiates the device from the side of the carrier 70 (e.g. outdoor), the light enters the heat-insulation light-guide film through the carrier 70. The light may firstly undergo the refraction and interference through the multilayer membrane 705. The membrane 705 allows blocking or reflecting the light with specific optical band as required. Therefore, only the specific optical-band light is allowed to transmit the device. The other effects such as polarization or heat insulation may be provided. After that, the light enters the surface textural layer 701 via the substrate 703. The optical properties of the surface textural layer 701 allow the light to be guided to the other side (e.g. indoor). By the surface textural layer 701, for example, the entering light serves the indoor illumination.

FIG. 7B shows the heat-insulation light-guide film using its surface textural layer 701 to adhere to the carrier 70.

The pressure-sensitive glue or optical glue may be the adhesive means applied to combine the surface textural layer 701 with the carrier 70 since the surface microstructure may not be a good plane. The gel-type glue 707 may fill in the space between the microstructure and the carrier 70. The surface structure with the corresponding surface microstructure may be formed. Furthermore, for preventing the glue 707 from changing the optical properties of the surface structure, the adopted gel-type glue 707 is an air-like index of refraction or low-refractivity glue 707 with around 1.2˜1.4 refractivity. The glue is such as Fluorine series or silicon functional group glue.

In one further embodiment of the present invention, the space between the surface textural layer 701 and the carrier 70 may be filled with a gas with a specific optical property. The gas, liquid or other matter is the substance featured that it does not change the optical property when it is filled in any device. The gas particularly makes impression on insulating heat or blocking light with a specific optical band. The thermal conductivity of the gas, such as argon, krypton or xenonis, is lower than air, and with effect of heat insulation. The noble gas may be adopted to improve the insulation capability. Further, any other gas or liquid which is able to insulate heat by reflecting infrared, or block ultraviolet.

According to the above-described applications of the claimed heat-insulation light-guide film, the surface structure of the film may not use singular structure but mixed with many. For example, the surface structure is composed of combination of patterns having arc-shaped column and triangular column. The combination may correspond with the need of various incident angles.

For example, the incident angle of outdoor sun with respect to the window may be varied from the morning through evening. The described combined surface structure allows the incident light to be guided to the indoor space at the different time with different incident angles.

### First Embodiment

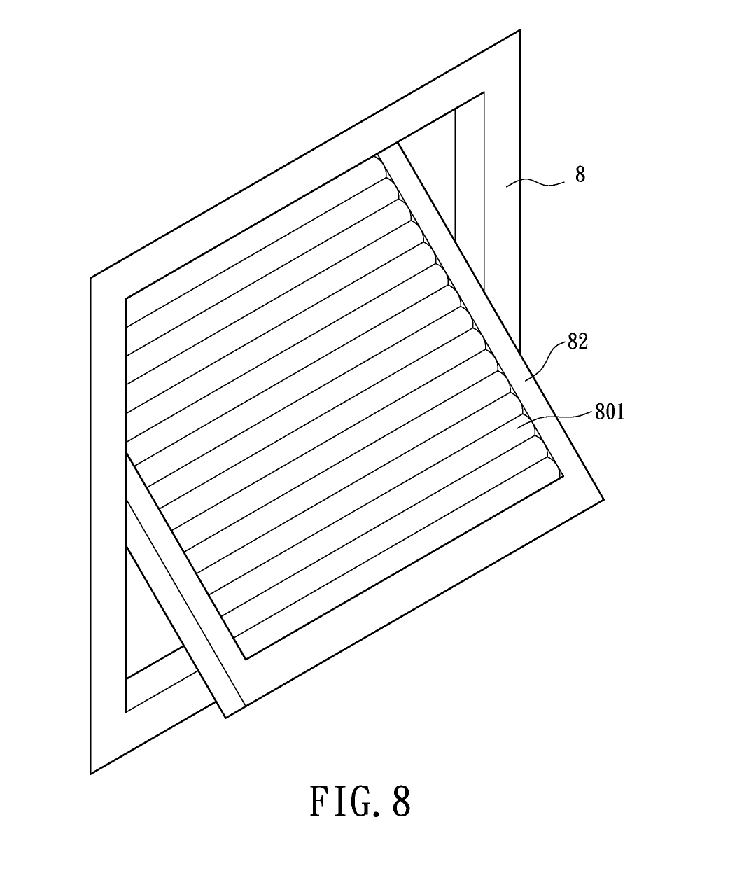

Reference is made to FIG. 8 illustrating one of the embodiments related to the claimed heat-insulation light-guide film.

A rotatable window member 82 is mounted onto a window frame 8. The detail description related to the window structure is unnecessary in the current case. It is noted that the window member 82 pivots on the window frame 8. The two ends of middle portion of the window member 82 are rotatably connected with the window frame 8.

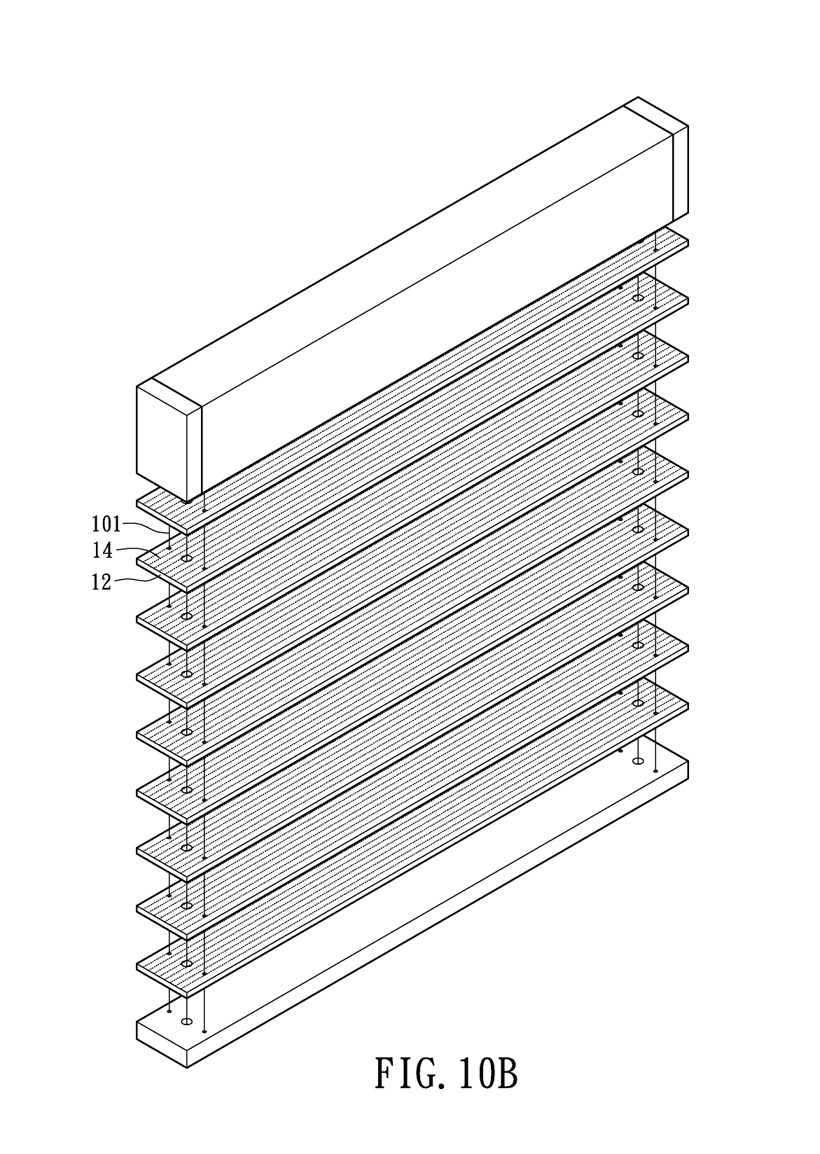

The window member 82 is as the carrier for carrying the heat-insulation light-guide film 801. Only one angle-adjustable carrying member is provided in the current case. For example, the window member 82 embodies the carrying member. Some other embodiments may be referred to FIGS. 10A and 10B. Multiple carrying members constitutes the carrier such as a window shutter which is a solid and stable window usually consisting of a frame of vertical stiles and horizontal rails.

A heat-insulation light-guide film 801 is mounted onto surface of the angle-adjustable window member 82. With the changes of angles of window member 82, the incident angle of the light enters the heat insulation light-guide film 801 alters. Therefore, this structure allows any user to modify the path of incident light as required. The angle of the window member 82 directs the illuminating angle of light guided by the heat-insulation light-guide film 801. Some other optical effects may also be introduced by this design.

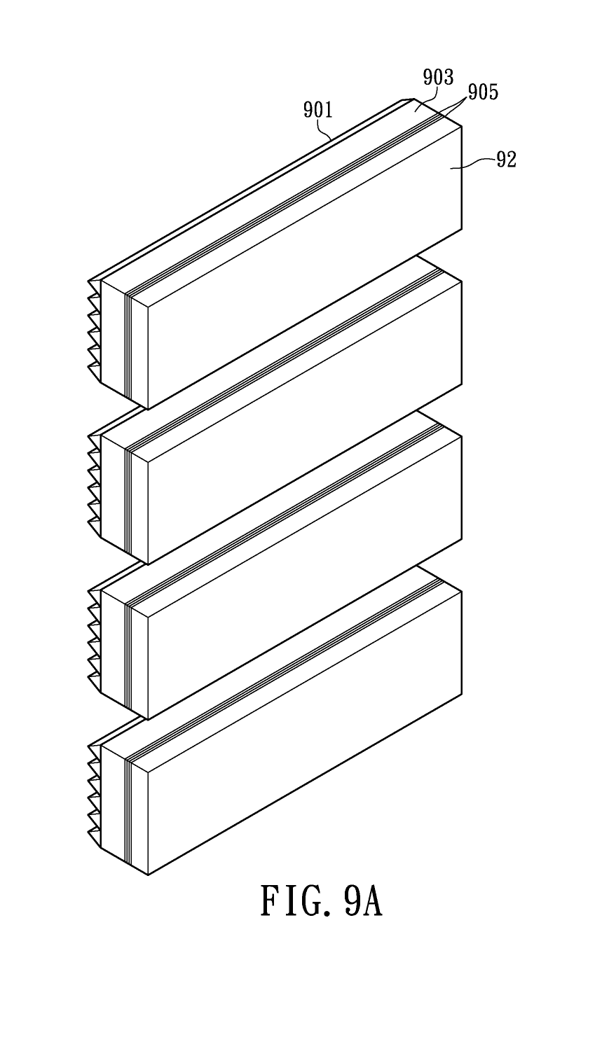

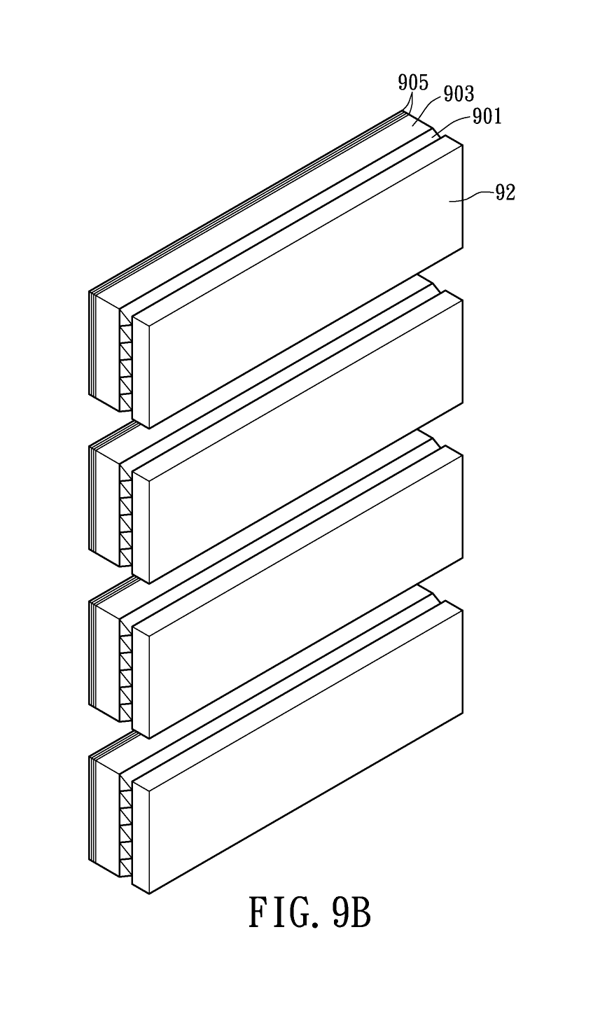

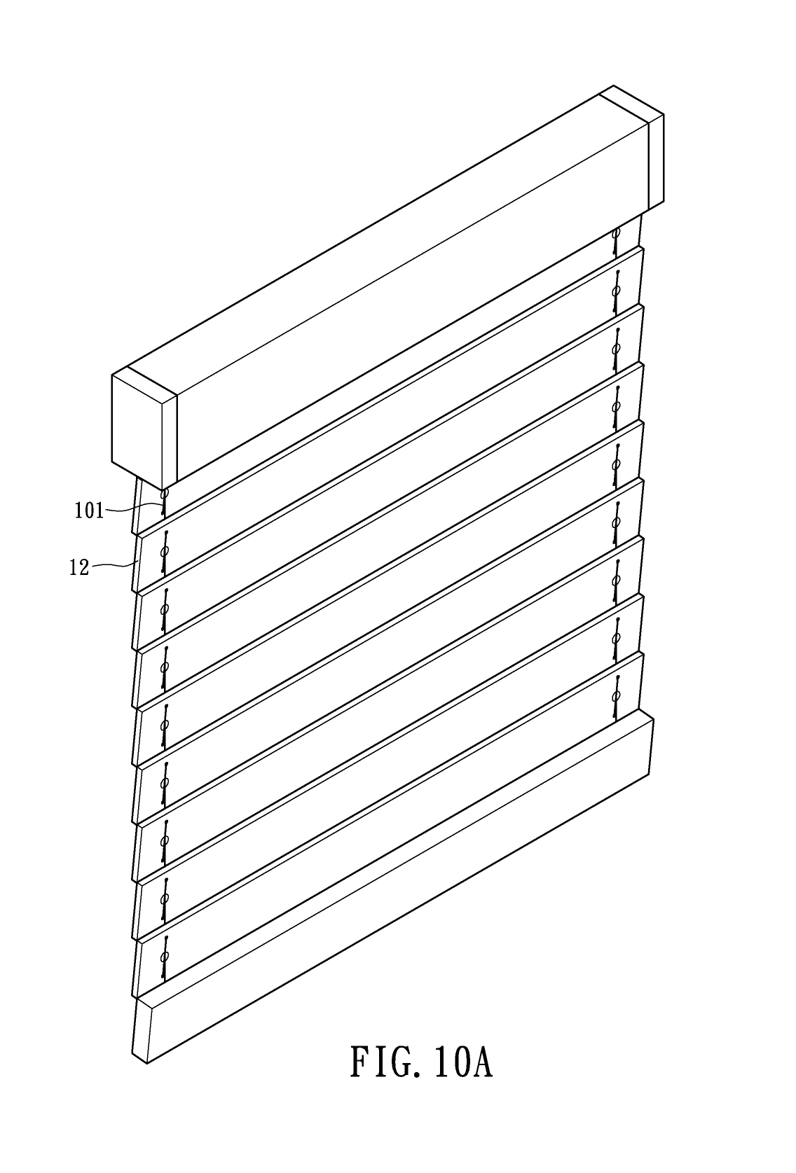

FIG. 9A further shows the schematic diagram illustrating multiple adjustable angles of the carrying member 92 of the window. Each carrying member 92 is mounted with the heat-insulation light-guide film exemplarily composed of a surface textural layer 901, a substrate 903 and a multilayer membrane 905. The combined structure forming the carrier is such as a window frame mounted onto a building wall. For example, a shutter is provided with disposal of a plurality of carrying members, on which a plurality of elongated slats are installed, and all the slats are angle-adjustable.

With the design of linked structure of the carrying members 92, the exemplary shutter may therefore drive the slats by a linked rope. The amount of incident light radiating the carrying members 92 is therefore adjustable. The angle of incident light entering the multiple heat-insulation light-guide films mounted on the carrying members 92 may also be adjustable. The adjusted optical features by tuning the angle of incident light may provide the various effects. For example, the capability of heat insulation may be adjusted. The angle of surface textural layer 901 is configured to modify the angle of illumination, the brightness of illumination, and the visual effect as the light radiating the space.

In accordance with the above described embodiments, the heat-insulation light-guide film adhered to the carrying member 92 is via the side of the multilayer membrane 95. In practice, there is no need to set all the carrying members 92 to be adhered to the heat-insulation light-guide film, but part of the members 92.

FIG. 9B shows the embodiment illustrating the heat-insulation light-guide film adhered to the carrying member 92 is via the side of surface textural layer 901. The carrying member is such as the slat of shutter. Similarly, not all the carrying members 92 need to be with the heat-insulation light-guide film but part of the members 92.

In the embodiment shown in FIG. 9B, a space is existed between the surface textural layer 901 and the slat. A low-refractivity glue may be filled in a space between the surface textural layer and the slat. Use of low-refractivity glue intends not to affect the optical path of incident light. Furthermore, such as the example described in FIG. 7B, a gas with a specific optical property may also be filled in a space between the surface textural layer and the slat. The gas makes impression on insulating heat or blocking light with a specific optical band. Further, the thermal conductivity of the gas may be lower than air in order to enhance the heat insulation.

Furthermore, the carrying member 92 is such as the elongated slat of shutter and which is angle-adjustable by a linked member. All or part of the slats is installed with the claimed heat-insulation light-guide films. References are made to FIGS. 10A and 10B showing the apparatuses installed with the heat insulation light-guide films.

FIG. 10A shows the shutter is closed. Structure of the shutter includes upper and lower shafts suspending a plurality of elongated slats 12. The plurality of slats 12 are upper-to-lower linked through a linked rope 101. An external controlling member may be incorporated to driving the linked rope 101 to move the slats 12. The related positions of the supporting points to the slats are then changed for controlling the rotating angle of the linked slats 12. Therefore, the angle of the linked slats controls the amount of incident light.

FIG. 10B further shows the shutter is opened. The slats 12 are suspended and driven by a linked rope 101. The shown structure is such as the shutter which is no need to specify in detail.

The above-mentioned controlling member drives the linked rope 101 for rendering the slats 12 to be an open state having an angle. The surface of each slat 12 is mounted with a heat-insulation light-guide film 14. The related disposal may be referred to FIGS. 9A and 9B. Driving the rotating angle of the slat 12 is to modify amount of the incident light, and also change the angle of the light entering the heat-insulation light-guide film 14. Therefore, a specific optical feature is introduced.

To sum up the above description, the apparatus installed with the heat-insulation light-guide film in the disclosure includes the angle-rotatable carrying member. By changing the incident angle of the light, the film provides a specific optical feature such as changing the path of light, or the effect of blocking infrared.

It is intended that the specification and depicted embodiment be considered exemplary only, with a true scope and spirit of the invention being indicated by the broad meaning of the following claims.

What is claimed is:

1. An apparatus having a heat insulation light-guide film, comprising:
a carrier having one or more angle-adjustable carrying members; and
one or more heat-insulation light-guide films, combined with the one or more carrying members of the carrier at the same or different sides, wherein the each heat-insulation light-guide film comprises:
a multilayer membrane, made of a plurality thin-film layers of polymeric materials; in which the adjacent films are with different indexes of refraction, and an optical band configured to be reflected is controlled based on the multilayer membrane's compositions and thickness;
a surface textural layer, combined with one side of the multilayer membrane, for guiding an optical path of the incident light entering the heat insulation light-guide film.

2. The apparatus according to claim 1, wherein the carrier is a shutter disposed on a window frame of a building.

3. The apparatus according to claim 2, on which the shutter is disposed with a plurality of carrying members that include a plurality of linked angle-adjustable slats.

4. The apparatus according to claim 3, wherein all or part of the angle-adjustable slats are disposed with the heat-insulation light-guide film.

5. The apparatus according to claim 4, wherein, the every heat-insulation light-guide film is adhered to the slat through the side of the multilayer membrane.

6. The apparatus according to claim 4, wherein, the every heat-insulation light-guide film is adhered to the slat through the side of the surface textural layer.

7. The apparatus according to claim 6, wherein, a provision of low-refractivity glue is filled in a space between the surface textural layer and the slat.

8. The apparatus according to claim 6, wherein, a gas with a specific optical property is filled in a space between the surface textural layer and the slat.

9. The apparatus according to claim 8, wherein the gas makes impression on insulating heat or blocking light with a specific optical band.

10. The apparatus according to claim 9, wherein the gas' thermal conductivity is lower than air.

11. The apparatus according to claim 1, wherein, the each heat insulation light-guide film further comprises a substrate disposed between the multilayer membrane and the surface textural layer, and a provision of glue is applied to combine the substrate, the multilayer membrane and the surface textural layer.

12. The apparatus according to claim 11, wherein the substrate is composed of glasses or polymeric materials.

13. The apparatus according to claim 12, wherein a cross-section of the surface textural layer appears a geometric shape and the structure with the geometric shape is columnar structure extended over the substrate surface.

14. The apparatus according to claim 13, wherein the surface textural layer is the columnar structure, which is mixed with a plurality of patterns, extended over the substrate surface.

15. The apparatus according to claim 1, wherein cross-section of the surface textural layer of the heat-insulation light-guide film appears a geometric shape and the structure with the geometric shape is columnar structure extended over surface of the multilayer membrane.

16. The apparatus according to claim 15, wherein the surface textural layer is the columnar structure, which is mixed with a plurality of patterns, extended over surface of the multilayer membrane.

17. The apparatus according to claim 1, wherein, an infrared light is blocked through an adjustment on material compositions and thickness of the multilayer membrane of the heat insulation light-guide film.

18. The apparatus according to claim 1, wherein the multilayer membrane renders a polarization appearing refractivity difference along different directions through a stretching process, and makes the slats able to polarize light.

19. The apparatus according to claim 18, wherein the stretching process is a uniaxial stretching process or a biaxial stretching process.

20. The apparatus according to claim 1, wherein the multilayer membrane is composed of a plurality of multilayer film modules and each multilayer film module has individual function and is composed of a plurality of thin films, wherein the adjacent thin films have different indexes of refraction.
